(19) United States
(12) Patent Application Publication
(10) Pub. No.: US 2008/0171107 A1
(43) Pub. Date: Jul. 17, 2008

(54) Sport / Nutraceutical Jerky

(76) Inventors: Jeff Jerome, Boise, ID (US); Kris Bristol, Boise, ID (US)

Correspondence Address: Jeff Jerome, 6702 Desert Ave, Boise, ID, 83709, US

(21) Appl. No.: 11/622,416

(22) Filed: Jan. 11, 2007

(51) Int. Cl. A23L 1/303; A23L 1/22; A23L 1/31

(52) U.S. Cl. 426/73; 426/641; 426/650

(57) ABSTRACT

A method of creating jerky formulations through a nutraceutical marinade that result in the creation of sports enhanced supplemental jerky. This allows individuals to supplement their nutraceutical intake while traveling or participating in athletic activities without storing or transporting supplements or liquids required to take supplements.

### BACKGROUND OF THE INVENTION

People have long used dried meat, also referred to as jerky, as a convenient portable source of high protein and low fat food. The formulations listed in this provisional patent allow for several enhancing nutraceuticals to be implemented into the Jerky.

Previous to the nutraceutical formulations described in this provisional patent, there was not a method of getting the benefits of the nutritional supplements listed without additional supplements that included their own source of hydration and storage.

Currently if you want to benefits from the listed sports enhancing nutraceuticals, you must purchase them separately and store each supplement along with transporting liquid for ingesting the supplements.

It is therefore an object of the invention to provide a nutraceutical enhanced dried meat for use as a convenient food product supplying high protein and high nutrient to individuals.

It is another object of the invention to provide a way to achieve supplemental nutraceuticals without the inconvenience of transporting or storing supplements or liquid beverages containing the supplements.

### The Field of the Invention

This invention is in the field of dehydrated meat products being useful to provide high protein food that is lightweight, portable, and in a convenient packaging. As well as providing nutritional supplementation in one source for the needs of the individual.

### The Relevant Technology

Many forms of diet supplementation are available for people to carry with them and consume when needed. Most are in the form of either energy drinks or energy bars. Energy drinks are heavy and sometimes inconvenient. Energy bars may lack the high protein and taste that dehydrated meats can provide. This present invention utilizes the usefulness of nutritional supplements with the convenience and high protein of dehydrated meat.

A marinade is prepared containing the desired concentrations of a nutritional supplement. Animal meat that is cut appropriately for jerky is soaked in the marinade. It has been tested that approximately half of the concentration of supplements will be absorbed into the meat upon marinating. The meat is then dehydrated in the desired method, whether in a dehydrator, an oven, in open air, or a meat smoker. The final product is a dried meat flavored with the desired marinade and supplemented with the appropriate Nutraceuticals.

### SUMMARY AND OBJECTS OF THE INVENTION

It is the object of the present invention to provide a dried meat product that is conveniently portable and contains the supplements that the individual desires to have with them impregnated in the dried meat.

It is another object of the present invention to create a marinade formulation containing Nutraceuticals for the purpose of soaking meat with said Nutraceuticals prior to dehydrating so as to create a dried meat product containing said Nutraceuticals.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an animal product plus nutraceutical formulation plus drying process =sport or nutraceutical jerky.

For purposes of clarity and brevity, like elements and components will bear the same designations and numbering throughout the Figures.

### DETAILED DESCRIPTION OF THE PREFERRED EMBODIMENTS

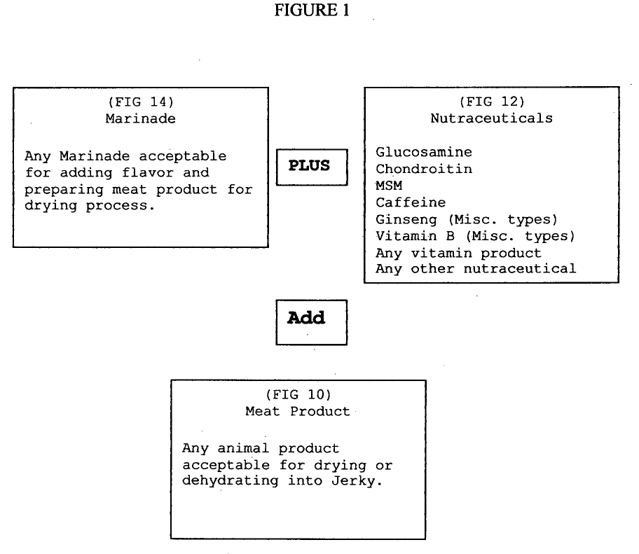

FIG. 1 is a perspective view of a dehydrated Animal Product (10) plus nutraceutical (12) in a marinade (14) to create sport jerky.

A dehydrated Animal product (10) is added to a marinade (14) that has appropriate nutraceutical (12) formulation for a minimum of 30 minutes.

What is claimed is:

1. A jerky formulation for Nutraceutical Sport Jerky, comprising:
A) Any animal meat product acceptable for dehydrating into jerky, to provide a high protein and low fat vehicle for the nutraceutical;
B) A ginseng, any assortment of minerals and vitamins including but not limited to the Vitamin B complex, Vitamin C, Taurine, 1-Carnitine, Vitamin A, caffeine, glucosamine, chondroitin, and MSM, or any other nutraceutical, for sport enhancing supplement to the meat product; and
C) A liquid marinade, for soaking the meat product to prepare the meat for the drying process, rigidly connected to said Nutraceutical.

2. A marinade comprising components: flavors, salt, and any of the above mentioned Nutraceuticals.

3. A dehydrated animal product comprising: a) the animal meat, and b) impregnated nutraceutical.

4. A method for preparing a dehydrated animal product comprising soaking said animal product in a marinade comprising components X, Y, or Z (see claim 1).

5. A method for preparing a marinade comprising mixing a marinade with the desired concentrations of Nutraceuticals to achieve the composition suitable for the marketed application.
